(19) United States
(12) Patent Application Publication
(10) Pub. No.: US 2026/0001767 A1
(43) Pub. Date: Jan. 1, 2026

(54) METHOD FOR MODIFYING MATERIAL THROUGH RAPID SURFACE GRAFTING, AND USE THEREOF

(71) Applicant: SHANGHAI JIAO TONG UNIVERSITY, Shanghai (CN)

(72) Inventors: Gangsheng TONG, Shanghai (CN); Ning REN, Shanghai (CN); Xinting WU, Shanghai (CN); Xinyuan ZHU, Shanghai (CN); Mao LI, Shanghai (CN)

(73) Assignee: SHANGHAI JIAO TONG UNIVERSITY, Shanghai (CN)

(21) Appl. No.: 19/319,862

(22) Filed: Sep. 5, 2025

Related U.S. Application Data
(63) Continuation of application No. PCT/CN2023/082415, filed on Mar. 20, 2023.

(30) Foreign Application Priority Data
Mar. 16, 2023 (CN) 202310258291.3

(51) Int. Cl. C01B 32/174; B82Y 40/00; C01B 32/194; C01B 33/18; C01G 7/00; C08G 81/02; D01F 11/14

(52) U.S. Cl. CPC C01B 32/174; C01B 32/194; C01B 33/18; C01G 7/00; C08G 81/024; D01F 11/14; B82Y 40/00; C01P 2004/13; C01P 2004/20; C01P 2004/32; C01P 2004/61; C01P 2004/64; D10B 2101/12

(57) ABSTRACT

A method for modifying a material through rapid surface grafting, and a use thereof are provided. In the method, with an olefin-functionalized nanomaterial as a model matrix, a cycloolefin as a polymerization monomer, a Grubbs catalyst as an initiator, and ethyl vinyl ether as a terminator, surface olefin cross-metathesis is conducted to prepare a polyolefin-grafted nanomaterial. In the use, with a thermoplastic resin as a matrix and the surface-polyolefin-grafted nanomaterial as a reinforcing material, a composite is prepared. The compatibility between the reinforcing material and the thermoplastic resin matrix is evaluated through cross-sectional morphology and mechanical performance characterization. A chain-transfer reaction is adopted as an alternative approach for surface-initiated ring-opening metathesis polymerization to avoid the growth of polymer chains from the surface. This alternative approach can significantly improve a reaction rate, shorten a reaction time, and simplify a technical flow, and demonstrates a promising industrialization prospect.

### CROSS REFERENCE TO THE RELATED APPLICATIONS

This application is a continuation application of International Application No. PCT/CN2023/082415, filed on Mar. 20, 2023, which is based upon and claims priority to Chinese Patent Application No. 202310258291.3, filed on Mar. 16, 2023, the entire contents of which are incorporated herein by reference.

### TECHNICAL FIELD

The present disclosure belongs to the fields of surface polymerization technology and interfacial compatibility in composites, and relates to a method for modifying a material through rapid surface grafting, and a use thereof. In particular, the present disclosure provides a method for preparing a polyolefin-grafted nanomaterial based on olefin cross-metathesis, and a use of the polyolefin-grafted nanomaterial as a reinforcing material in improving compatibility of the reinforcing material with a thermoplastic resin matrix.

### BACKGROUND

Surface-initiated polymerization is a polymerization technique initiated on a surface of a material. Surface-initiated polymerization is extensively used in fields such as nanocomposites, hydrophobic materials, ion-exchange membranes, and responsive surfaces. The common surface-initiated polymerization can be classified into the following three categories: surface-initiated controlled radical polymerization, surface-initiated anionic or cationic polymerization, and surface-initiated ring-opening metathesis polymerization. The surface-initiated ring-opening metathesis polymerization expands the synthetic pathways of unsaturated and saturated functionalized surfaces for polymer-grafted nanoparticles and has attracted great industrial interest.

In recent years, there have been increasing studies on the surface modification for nanomaterials based on surface-initiated ring-opening metathesis polymerization. This surface modification method typically involves the following steps: An olefin group is functionalized on a surface of a material through covalent or non-covalent bonding. Then, the Grubbs catalyst attaches to the surface of the material by reacting with an olefin bond. Finally, polymerization monomers are grafted on the surface of the material one by one through a ring-opening metathesis mechanism. However, this surface modification method involves a two-step surface modification process and enables a limited reaction rate because the initiator exists merely on the surface. Therefore, it is challenging to develop an alternative method that can simplify a modification route and improve the efficiency.

Since the introduction of composites in the 1940s, composites have gradually replaced the traditional materials, including woods and metal alloys, due to properties such as light weight, high strength, easy processing and molding, and excellent chemical resistance and weather resistance. Thus, composites are widely applied to aerospace, electronics, automotive, construction, and other fields. Since the 21st century, the global demand for composites has experienced exponential growth. Particularly, resin-based composites have emerged as a research focus in recent years. Over several years, the State Council of the People's Republic of China and other related departments have issued a series of policy documents, such as Made in China 2025, Guidelines for Accelerating Innovation and Development of New Materials Industry, and Development Guide for New Materials Industry, emphasizing the strategic importance of high-performance composites.

Resin-based composites are divided into thermoplastic resin-based composites and thermosetting resin-based composites based on different matrices. While maintaining comparable mechanical properties to the thermosetting resin-based composites, the thermoplastic resin-based composites exhibit advantages not possessed by the thermosetting resin-based composites, such as rapid molding, easy recycling, long storage time, and short production cycle. Thus, the thermoplastic resin-based composites have a promising application prospect. However, due to the chemical inertness and low surface energy of surfaces of most thermoplastic resins and reinforcing materials, it is difficult to achieve the desirable interfacial compatibility between thermoplastic resins and reinforcing materials, which has become a key factor affecting the performance of thermoplastic resin-based composites. Currently, there are few processes available to improve the interfacial compatibility in thermoplastic resin-based composites, and there is an urgent need to develop a method for enhancing the compatibility between a reinforcing material and a thermoplastic resin matrix.

### SUMMARY

In view of the deficiencies in the prior, the present disclosure proposes a novel process for preparing a polyolefin-grafted nanomaterial based on surface olefin cross-metathesis. Specifically, the present disclosure provides a polymerization method for modifying a material through rapid surface grafting, and a use thereof.

The present disclosure is implemented through the following technical solutions:

In a first aspect, the present disclosure provides a polymerization method for modifying a material through rapid surface grafting, including: with an olefin-functionalized nanomaterial as a model matrix, a cycloolefin as a polymerization monomer, and a Grubbs catalyst as an initiator, conducting surface olefin cross-metathesis to prepare a polyolefin-grafted nanomaterial.

In this reaction, under the action of the Grubbs catalyst, the cycloolefin monomers undergo polymerization while the resulting polymer undergoes chain-transfer cross-metathesis with an olefin bond on a surface of an olefin-functionalized carbon nanotube. When 1,5-cyclooctadiene is adopted as a polymerization monomer, a reaction mechanism is as follows: under the action of the Grubbs catalyst, an olefin bond on a surface of an olefin-functionalized carbon nanotube undergoes chain-transfer cross-metathesis with a 1,5-cyclooctadiene polymerization product.

As an embodiment of the present disclosure, a nanomaterial includes at least one of a carbon nanotube, a graphene nanosheet, a carbon fiber, a silica microsphere, a gold nanoparticle, a glass fiber, an aramid fiber, and an ultra-high-molecular-weight polyethylene fiber. That is, the model matrix can be any material whose surface is functionalized with an olefin, including: an olefin-functionalized carbon nanotube, an olefin-functionalized graphene nanosheet, an olefin-functionalized carbon fiber, an olefin-functionalized silica microsphere, an olefin-functionalized gold nanoparticle, an olefin-functionalized glass fiber, an olefin-functionalized aramid fiber, and an olefin-functionalized ultra-high-molecular-weight polyethylene fiber.

As an embodiment of the present disclosure, the cycloolefin includes at least one of cyclohexene, cycloheptene, cyclooctene, norbornene, norbornadiene, cyclododecene, and 1,5-cyclooctadiene. The grafted polymer is any polymer with an olefin bond in a backbone, including: polycyclohexene, polycycloheptene, polycyclooctene, a polynorbornene-based polymer, polycyclooctadiene, etc.

As an embodiment of the present disclosure, the polymerization is terminated by adding ethyl vinyl ether to a system.

As an embodiment of the present disclosure, the olefin-functionalized nanomaterial is produced by grafting a long-chain alkyl molecule with a α-olefin bond on a surface of a nanomaterial. Non-α-olefin molecules are not applicable to the present disclosure. The long-chain alkyl molecule with a α-olefin bond includes, but is not limited to, 3-(trimethoxysilyl) propyl acrylate and 10-undecene-1-thiol.

As an embodiment of the present disclosure, when a nanomaterial is a carbon nanotube, a graphene nanosheet, or a carbon fiber, the olefin-functionalized nanomaterial is prepared through a process including the following steps:
A1, nitric acid oxidation: adding the nanomaterial to nitric acid, heating to a temperature of 80° C. to 90° C., holding the temperature of 80° C. to 90° C. for 2 h to 12 h, cooling, and centrifuging; and
A2, under an acidity and in the presence of water, subjecting an oxidized nanomaterial and 3-(trimethoxysilyl) propyl acrylate to a reaction for 1 h to 8 h at 20° C. to 30° C. under stirring, washing, and drying to produce the olefin-functionalized nanomaterial, where the acidity refers to a pH of 3 to 4.

As an embodiment of the present disclosure, the nanomaterial is a desized carbon fiber. In this case, the olefin-functionalized nanomaterial is prepared as follows: adding the desized carbon fiber to nitric acid, heating to a temperature of 80° C. to 90° C., holding the temperature of 80° C. to 90° C. for 2 h to 12 h, cooling, washing with deionized water, and oven-drying; and adding a 3-(trimethoxysilyl) propyl acrylate aqueous solution with a pH of 3 to 4, conducting a reaction for 1 h to 8 h at 20° C. to 30° C. under stirring, washing, and drying. The desized carbon fiber is prepared as follows: placing a carbon fiber in a Soxhlet extractor, adding N,N-dimethylformamide, heating to 160° C. to 180° C., and allowing reflux overnight; and cooling, washing with N,N-dimethylformamide and deionized water, and oven-drying to produce the desized carbon fiber.

As an embodiment of the present disclosure, in the step A1, the nanomaterial is a carbon nanotube. In this case, the carbon nanotube is added to nitric acid and dispersed for 20 min to 40 min, and a resulting dispersion is heated to a temperature of 80° C. to 90° C., kept at the temperature of 80° C. to 90° C. for 2 h to 12 h, then cooled, continuously centrifuged with deionized water, and subjected to ultrasonic dispersion until a resulting system has a pH of 3 to 4.

As an embodiment of the present disclosure, the nanomaterial, the nitric acid, and the 3-(trimethoxysilyl) propyl acrylate are in a mass ratio of 1:100:10 to 1:20,000:25, such as 1:100:10, 1:100:20, 1:500:10, 1:500:20, 1:1,000:10, 1:1,000:20, 1:2,000:10, 1:2,000:20, 1:5,000:10, 1:5,000:20, 1:8,000:10, 1:8,000:20, 1:10,000:10, 1:10,000:20, 1:20,000:10, 1:20,000:20, and 1:20,000:25.

As an embodiment of the present disclosure, a mass ratio of the 3-(trimethoxysilyl) propyl acrylate to the water is 1:25 to 1:200, such as 1:30, 1:40, 1:50, 1:60, 1:70, 1:80, 1:90, 1:100, 1:110, 1:120, 1:130, 1:140, 1:150, 1:160, 1:170, 1:180, 1:190, and 1:200.

As an embodiment of the present disclosure, when the nanomaterial is a silica microsphere, the olefin-functionalized nanomaterial is prepared through a process including the following steps: under an acidity and in the presence of water, subjecting the nanomaterial and 3-(trimethoxysilyl) propyl acrylate to a reaction for 1 h to 8 h at 20° C. to 30° C. under stirring, washing, and drying to produce the olefin-functionalized nanomaterial, where the acidity refers to a pH of 3 to 4.

As an embodiment of the present disclosure, when the nanomaterial is a gold nanoparticle, the olefin-functionalized nanomaterial is prepared through a process including the following steps: in the presence of water, subjecting the nanomaterial and 10-undecene-1-thiol to a reaction for 1 h to 8 h at 20° C. to 30° C. under stirring, washing, and drying produce the olefin-functionalized nanomaterial.

As an embodiment of the present disclosure, the surface olefin cross-metathesis includes the following steps:
B1, in the presence of a tetrahydrofuran solvent and a Grubbs catalyst, subjecting the olefin-functionalized nanomaterial and the cycloolefin to a reaction for 30 min to 4 h at 20° C. to 30° C. under stirring; and
B2, adding ethyl vinyl ether for termination, centrifuging, washing, and drying to produce the polyolefin-grafted nanomaterial.

As an embodiment of the present disclosure, a mass ratio of the olefin-functionalized nanomaterial to the cycloolefin is 1:1 to 1:100, such as 1:1, 1:5, 1:10, 1:15, 1:20, 1:25, 1:30, 1:35, 1:40, 1:50, 1:60, 1:70, 1:80, 1:90, and 1:100. A molar ratio of the cycloolefin to the tetrahydrofuran is 1:4 to 1:400, such as 1:5, 1:10, 1:15, 1:20, 1:30, 1:40, 1:50, 1:60, 1:80, 1:100, 1:150, 1:200, 1:250, 1:300, 1:350, and 1:400. A molar ratio of the Grubbs catalyst to the cycloolefin is 1:20 to 1:400, such as 1:20, 1:30, 1:40, 1:50, 1:60, 1:80, 1:100, 1:150, 1:200, 1:250, 1:300, 1:350, and 1:400.

In some embodiments, steps for preparing a polycyclooctadiene-grafted carbon nanotube with an olefin-functionalized carbon nanotube as a model matrix are as follows: adding a carbon nanotube to a reaction vessel with nitric acid, and conducting ultrasonic dispersion for 30 min; heating to a temperature of 80° C. to 90° C., and holding the temperature of 80° C. to 90° C. for 2 h to 12 h; cooling, conducting continuous centrifugation with deionized water, and conducting ultrasonic dispersion until a resulting system has a pH of 3 to 4; adding 3-(trimethoxysilyl) propyl acrylate, and conducting a reaction for 1 h to 8 h at room temperature under stirring; centrifuging, and drying to produce the olefin-functionalized carbon nanotube;
adding the olefin-functionalized carbon nanotube to a solution of 1,5-cyclooctadiene in tetrahydrofuran, adding a Grubbs catalyst, and conducting a reaction for 30 min to 4 h at room temperature under stirring; and adding ethyl vinyl ether for termination, conducting continuous centrifugation with tetrahydrofuran, and drying to produce the polycyclooctadiene-grafted carbon nanotube.

A mass ratio of the 3-(trimethoxysilyl) propyl acrylate to the water is 1:25 to 1:200. A molar ratio of the 1,5-cyclooctadiene to the tetrahydrofuran is 1:4 to 1:400. A molar ratio of the Grubbs catalyst to the 1,5-cyclooctadiene is 1:20 to 1:400.

After being oxidized by nitric acid, the nanomaterial (such as a carbon nanotube) as a model monomer used in the present disclosure is rich in hydroxyl groups on a surface, and thus can undergo a hydrogen bonding interaction with 3-(trimethoxysilyl) propyl acrylate in an aqueous solution at a pH of 3 to 4, thereby achieving the grafting of olefin bonds on the surface of the nanomaterial. Under the action of the Grubbs catalyst, the olefin-functionalized carbon nanotube can undergo chain-transfer cross-metathesis with a cycloolefin (such as 1,5-cyclooctadiene) polymerization product to produce a nanomaterial grafted with a polyolefin (such as polycyclooctadiene) on a surface. A polyolefin can be synthesized through ring-opening metathesis either concurrently with the surface chain-transfer process or before the surface grafting. In addition, because the olefin cross-metathesis can occur on any olefin bond in a molecular chain of a polymer and a length of a polymer chain grafted to a surface is smaller than a length of a molecular chain in the original solution, the molecular weight of a polymer in a system produced after a reaction is reduced, and the molecular weight distribution is broadened.

In some other embodiments, N,N-dimethylformamide is adopted as a desizing agent, nitric acid is adopted as an oxidant, and 3-(trimethoxysilyl) propyl acrylate is adopted as an olefin functionalizing reagent. A commercial carbon fiber is placed in a Soxhlet extractor, N,N-dimethylformamide is added, heating is conducted to 170° C., and reflux is allowed overnight; and cooling is allowed, washing is conducted with N,N-dimethylformamide and deionized water, and oven-drying is conducted to produce a desized carbon fiber. The desized carbon fiber is added to a reaction vessel with nitric acid, kept at a constant temperature of 80° C. to 90° C. for 2 h to 12 h, cooled, fully washed with deionized water, and oven-dried to produce a surface-hydroxylated carbon fiber.

The surface-hydroxylated carbon fiber is added to a 3-(trimethoxysilyl) propyl acrylate aqueous solution with a pH of 3 to 4, stirred at room temperature for 1 h to 8 h, rinsed with deionized water, and oven-dried to produce a surface-olefin-functionalized carbon fiber. A molar ratio of the 1,5-cyclooctadiene to the tetrahydrofuran is 1:4 to 1:400. A molar ratio of the Grubbs catalyst to the 1,5-cyclooctadiene is 1:20 to 1:400. A mass ratio of the 3-(trimethoxysilyl) propyl acrylate to the water is 1:25 to 1:200.

A polyolefin-grafted carbon fiber is prepared through chain-transfer cross-metathesis between an olefin-functionalized carbon fiber and polycyclooctadiene, and specific preparation steps can be as follows:
adding 1,5-cyclooctadiene to tetrahydrofuran, adding a Grubbs catalyst, and conducting a reaction for 5 min to 30 min at room temperature under stirring to produce a tetrahydrofuran solution including the Grubbs catalyst and polycyclooctadiene;
adding the olefin-functionalized carbon fiber to the solution, and conducting a reaction for 30 min to 4 h at room temperature under stirring; and adding ethyl vinyl ether for termination, washing with tetrahydrofuran, and drying to produce a polycyclooctadiene-grafted carbon fiber. In the preparation method of the polyolefin-grafted carbon fiber, a mass ratio of 3-(trimethoxysilyl) propyl acrylate to water is 1:25 to 1:200, a molar ratio of 1,5-cyclooctadiene to tetrahydrofuran is 1:4 to 1:400, and a molar ratio of a Grubbs catalyst to 1,5-cyclooctadiene is 1:20 to 1:400.

In a second aspect, the present disclosure also provides a use of a polyolefin-grafted nanomaterial prepared by the method described above, including: with a thermoplastic resin as a matrix and the polyolefin-grafted nanomaterial as a reinforcing material, preparing a nanomaterial-reinforced resin material.

As an embodiment of the present disclosure, the thermoplastic resin includes at least one of polyethylene, polyvinyl chloride, polystyrene, polyformaldehyde, polycarbonate, polyamide, and polypropylene. A mass ratio of the thermoplastic resin matrix to the polyolefin-grafted nanomaterial is 2:1 to 99:1, such as 5:1, 10:1, 15:1, 20:1, 30:1, 40:1, 50:1, 60:1, 70:1, 80:1, 90:1, 95:1, and 99:1.

In some embodiments, with polypropylene as a matrix and a surface-polyolefin-grafted carbon fiber as a reinforcing material, a carbon fiber-reinforced polypropylene composite is prepared through compression molding. The compatibility between the reinforcing material and the thermoplastic resin matrix is evaluated through cross-sectional morphology and mechanical performance characterization (the cross-sectional morphology is characterized by scanning electron microscopy, and the mechanical performance is characterized by dynamic thermomechanical analysis). A mass ratio of a polypropylene granule to the polyolefin-grafted carbon fiber is 2:1 to 99:1.

In some embodiments, a specific method for preparing a carbon fiber-reinforced polypropylene composite through compression molding is provided, including the following steps:
adding a polypropylene granule and a polyolefin-grafted carbon fiber to a 80 mm×10 mm×2 mm stainless steel mold, placing the mold in a platen vulcanizing machine heated to 210° C., and holding the 210° C. for 20 min under a pressure of 7.5 MPa; and cooling the mold at 20° C. for 0.5 h, demolding, and placing for 48 h or more at a temperature of 25° C. and a relative humidity of 50% for later use. In the method for preparing a carbon fiber-reinforced polypropylene composite, a mass ratio of the polypropylene granule to the polyolefin-grafted carbon fiber is 2:1 to 99:1.

The compatibility evaluation method adopted in the present disclosure is achieved by combining scanning electron microscopy and dynamic thermomechanical analysis, and is specifically as follows:

A 1 mm-deep notch is created inwards at both sides of a carbon fiber-reinforced polypropylene composite specimen in a direction parallel to a short side, and then the specimen is embrittled in liquid nitrogen for 10 min to 20 min and broken along notches. A cross section is ultrasonically cleaned with deionized water, and then observed by scanning electron microscopy to determine a brittle fracture surface morphology between a carbon fiber and a polypropylene matrix.

A carbon fiber-reinforced polypropylene composite specimen is pulled by a tensile machine in a long side direction until broken. A cross section is ultrasonically cleaned with deionized water, and then observed by scanning electron microscopy to determine a tensile fracture surface morphology between a carbon fiber and a polypropylene matrix.

A carbon fiber-reinforced polypropylene composite specimen is tested by a dynamic thermomechanical analyzer in a single cantilever mode at a frequency of 1 Hz, −20° C. to 120° C. with a heating rate of 5° C./min, and a span of 17.5 mm.

To design an efficient and alternative solution, the strategy of the present disclosure is to replace ring-opening metathesis polymerization with a chain-transfer reaction in a solution. That is, a surface of a material is first functionalized with an olefin group, and then a polymer is directly grafted on the surface of the material through a chain-transfer reaction. The innovation of this method lies in the simplification of surface modification into a single step and the direct grafting of a polymer synthesized within a few minutes on a surface of a material, which not only saves the time for fixing a catalyst on the surface, but also shortens the process of monomer polymerization. In the present disclosure, this strategy is named as surface chain-transfer ring-opening metathesis polymerization.

### BRIEF DESCRIPTION OF THE DRAWINGS

Detailed description of non-limiting embodiments with reference to the following accompanying drawings:

FIG. 1 shows a reaction route for a polycyclooctadiene-grafted carbon nanotube in Example 1 of the present disclosure;

FIG. 2 shows a transmission electron microscopy image of the polycyclooctadiene-grafted carbon nanotube in Example 1 of the present disclosure;

FIG. 3 shows a transmission electron microscopy image of a polycyclooctadiene-grafted carbon nanotube in Example 2 of the present disclosure;

FIG. 4 shows a transmission electron microscopy image of a polycyclooctadiene-grafted carbon nanotube in Example 3 of the present disclosure;

FIG. 5 shows a scanning electron microscopy image of a polycyclooctadiene-grafted silica microsphere in Example 4 of the present disclosure;

FIG. 6 shows a scanning electron microscopy image of a polycyclooctadiene-grafted graphene nanosheet in Example 5 of the present disclosure;

FIG. 7 shows a scanning electron microscopy image of a surface-hydroxylated carbon fiber in Example 6 of the present disclosure;

FIG. 8 shows a scanning electron microscopy image of a surface-olefin-functionalized carbon fiber in Example 6 of the present disclosure;

FIG. 9 shows a scanning electron microscopy image of a polycyclooctadiene-grafted carbon fiber in Example 6 of the present disclosure;

FIG. 10 shows a change of an olefin bond content in a reaction system for a polycyclooctadiene-grafted carbon fiber in Example 7 of the present disclosure;

FIG. 11 shows a transmission electron microscopy image of a polycyclooctadiene-grafted gold nanoparticle in Example 8 of the present disclosure;

FIG. 12 shows a scanning electron microscopy image of a tensile fracture surface of a polycyclooctadiene-grafted carbon fiber-reinforced polypropylene composite specimen in Example 9 of the present disclosure;

FIG. 13 shows a scanning electron microscopy image of a brittle fracture surface of a non-grafting-modified carbon fiber-reinforced polypropylene composite specimen in Comparative Example 2 of the present disclosure;

FIG. 14 shows a scanning electron microscopy image of a tensile fracture surface of the non-grafting-modified carbon fiber-reinforced polypropylene composite specimen in Comparative Example 2 of the present disclosure;

FIG. 15 shows a scanning electron microscopy image of a brittle fracture surface of a polycyclooctadiene-grafted carbon fiber-reinforced polypropylene composite specimen in Example 10 of the present disclosure;

FIG. 16 shows a scanning electron microscopy image of a tensile fracture surface of a polycyclooctadiene-grafted carbon fiber-reinforced polypropylene composite specimen in Example 10 of the present disclosure; and

FIG. 17 shows storage modulus-temperature curves for a polypropylene specimen in Comparative Example 1, the non-grafting-modified carbon fiber-reinforced polypropylene composite specimen in Comparative Example 2, and the polycyclooctadiene-grafted carbon fiber-reinforced polypropylene composite specimen in Example 9 of the present disclosure.

### DETAILED DESCRIPTION OF THE EMBODIMENTS

The present disclosure is described in detail below with reference to specific examples. The following examples will help those skilled in the art to further understand the present disclosure, but do not limit the present disclosure in any way. It should be noted that those of ordinary skill in the art can further make several variations and improvements without departing from the idea of the present disclosure. These all fall within the protection scope of the present disclosure.

### Example 1

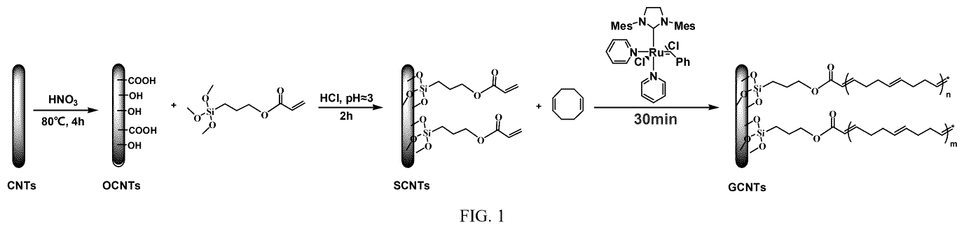

In this example, a method for rapidly grafting polycyclooctadiene on a surface of a carbon nanotube was provided, and a corresponding reaction route was shown in FIG. 1. The method specifically included the following steps:

20 mg of a carbon nanotube was dispersed in 10.0 mL of nitric acid, and a resulting system was heated to 80° C., stirred at a rate of 600 rpm to allow a reaction for 2 h, and cooled to room temperature. A resulting reaction solution was centrifuged at a rotational speed of 8,000 rpm for 10 min, and a resulting supernatant was discarded. A resulting surface-hydroxylated carbon nanotube was dispersed in 20 mL of deionized water and then centrifuged at a rotational speed of 8,000 rpm for 10 min. This centrifugation-dispersion process was repeated until a resulting surface-hydroxylated carbon nanotube dispersion had a pH of 3 to 4. 200 μL of 3-(trimethoxysilyl) propyl acrylate was added to the dispersion, stirring was conducted at room temperature for 1 h, and centrifugation was conducted at a rotational speed of 8,000 rpm for 10 min. A resulting surface-olefin-functionalized carbon nanotube was dispersed in 20 mL of deionized water, centrifuged at a rotational speed of 8,000 rpm for 10 min, and dried for later use.

The surface-olefin-functionalized carbon nanotube was dispersed in 1,755 μL of a tetrahydrofuran solution, 245 μL of 1,5-cyclooctadiene and 9.5 mg of a Grubbs catalyst were added, and a reaction was conducted for 30 min at room temperature under stirring. 50 μL of ethyl vinyl ether was added, and stirring was conducted for 5 min. Centrifugation was conducted at a rotational speed of 8,000 rpm for 10 min, and a resulting polycyclooctadiene-grafted carbon nanotube was dispersed in tetrahydrofuran. The centrifugation-dispersion process was repeated three times. A final polycyclooctadiene-grafted carbon nanotube was dried in a vacuum oven.

It can be seen from FIG. 2 that a polymer layer of the polycyclooctadiene-grafted carbon nanotube in this example has a thickness of 2.6 nm.

### Example 2

In this example, a method for rapidly grafting polycyclooctadiene on a surface of a carbon nanotube was provided. The method specifically included the following steps:

The surface-olefin-functionalized carbon nanotube obtained in Example 1 was dispersed in 1,755 μL of a tetrahydrofuran solution, 245 μL of 1,5-cyclooctadiene and 8.5 mg of a Grubbs catalyst were added, and a reaction was conducted for 30 min at room temperature under stirring. 50 μL of ethyl vinyl ether was added, and stirring was conducted for 5 min. Centrifugation was conducted at a rotational speed of 8,000 rpm for 10 min, and a resulting polycyclooctadiene-grafted carbon nanotube was dispersed in tetrahydrofuran. The centrifugation-dispersion process was repeated three times. A final polycyclooctadiene-grafted carbon nanotube was dried in a vacuum oven.

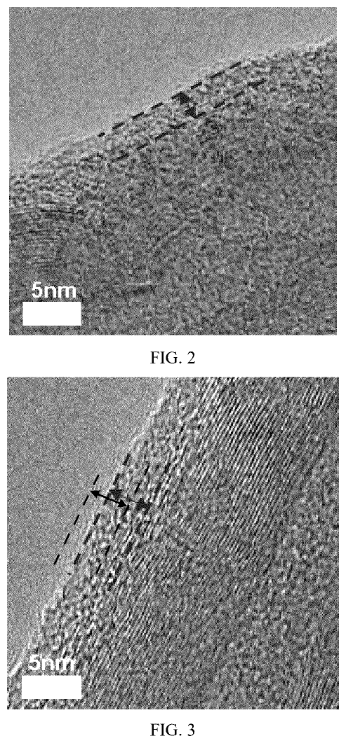

It can be seen from FIG. 3 that a polymer layer of the polycyclooctadiene-grafted carbon nanotube in this example has a thickness of 3.8 nm.

### Example 3

In this example, a method for rapidly grafting polycyclooctadiene on a surface of a carbon nanotube was provided. The method specifically included the following steps:

The surface-olefin-functionalized carbon nanotube obtained in Example 1 was dispersed in 1,755 μL of a tetrahydrofuran solution, 245 μL of 1,5-cyclooctadiene and 4.5 mg of a Grubbs catalyst were added, and a reaction was conducted for 30 min at room temperature under stirring. 50 μL of ethyl vinyl ether was added, and stirring was conducted for 5 min. Centrifugation was conducted at a rotational speed of 8,000 rpm for 10 min, and a resulting polycyclooctadiene-grafted carbon nanotube was dispersed in tetrahydrofuran. The centrifugation-dispersion process was repeated three times. A final polycyclooctadiene-grafted carbon nanotube was dried in a vacuum oven.

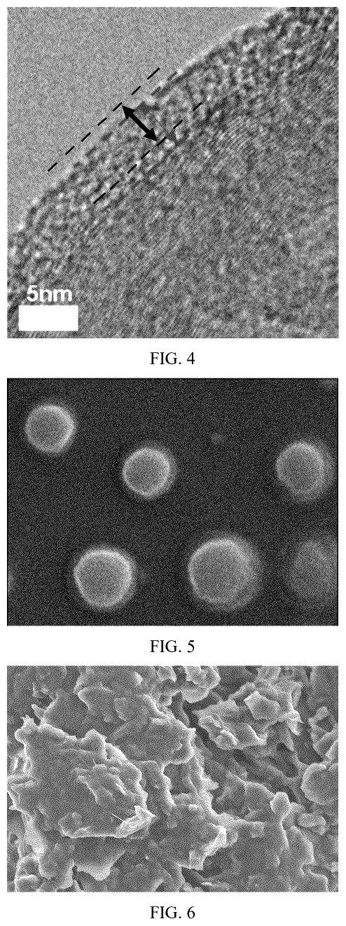

It can be seen from FIG. 4 that a polymer layer of the polycyclooctadiene-grafted carbon nanotube in this example has a thickness of 6.0 nm.

### Example 4

In this example, a method for rapidly grafting polycyclooctadiene on a surface of a silica microsphere was provided. The method specifically included the following steps:

19.0 mL of ammonia water was added to 200 mL of an ethanol solution, 12.0 mL of tetraethyl silicate was added in three batches slowly to a resulting solution under stirring at a rate of 1,200 rpm, and a reaction was conducted for 1 h at room temperature under stirring. A resulting dispersion was stirred overnight at a rate of 400 rpm. A resulting reaction solution was centrifuged for 5 min at a rotational speed of 7,000 rpm, and a resulting supernatant was discarded. A resulting silica microsphere was dispersed in 200 mL of ethanol, and centrifuged for 5 min at a rotational speed of 7,000 rpm. This centrifugation-dispersion process was repeated 3 times. A final silica microsphere was dispersed in deionized water. 3-(trimethoxysilyl) propyl acrylate was added to a resulting dispersion to prepare a 1.0 wt % aqueous solution, and a pH was adjusted with hydrochloric acid to 3 to 4. Stirring was conducted for 1 h at room temperature, and centrifugation was conducted for 5 min at a rotational speed of 7,000 rpm. Drying was conducted for later use.

The surface-olefin-functionalized silica microsphere was dispersed in 1,755 μL of a tetrahydrofuran solution, 245 μL of 1,5-cyclooctadiene and 4.5 mg of a Grubbs catalyst were added, and a reaction was conducted for 30 min at room temperature under stirring. 50 μL of ethyl vinyl ether was added, and stirring was conducted for 5 min. Centrifugation was conducted at a rotational speed of 7,000 rpm for 5 min, and a resulting polycyclooctadiene-grafted silica microsphere was dispersed in tetrahydrofuran. The centrifugation-dispersion process was repeated three times. A final polycyclooctadiene-grafted silica microsphere was dried in a vacuum oven.

It can be seen from FIG. 5 that a silica microsphere grafted with polycyclooctadiene on a surface is successfully prepared in this example.

### Example 5

In this example, a method for rapidly grafting polycyclooctadiene on a surface of a graphene nanosheet was provided. The method specifically included the following steps:

20 mg of a graphene nanosheet was dispersed in 10.0 mL of nitric acid, and a resulting system was heated to 80° C., stirred at a rate of 600 rpm to allow a reaction for 2 h, and cooled to room temperature. A resulting reaction solution was centrifuged at a rotational speed of 8,000 rpm for 10 min, and a resulting supernatant was discarded. A resulting surface-hydroxylated graphene nanosheet was dispersed in 20 mL of deionized water and then centrifuged at a rotational speed of 8,000 rpm for 10 min. This centrifugation-dispersion process was repeated until a resulting surface-hydroxylated graphene nanosheet dispersion had a pH of 3 to 4. 200 μL of 3-(trimethoxysilyl) propyl acrylate was added to the dispersion, stirring was conducted at room temperature for 1 h, and centrifugation was conducted at a rotational speed of 8,000 rpm for 10 min. A resulting surface-olefin-functionalized graphene nanosheet was dispersed in 20 mL of deionized water, centrifuged at a rotational speed of 8,000 rpm for 10 min, and dried for later use.

The surface-olefin-functionalized graphene nanosheet was dispersed in 1,755 μL of a tetrahydrofuran solution, 245 μL of 1,5-cyclooctadiene and 4.5 mg of a Grubbs catalyst were added, and a reaction was conducted for 30 min at room temperature under stirring. 50 μL of ethyl vinyl ether was added, and stirring was conducted for 5 min. Centrifugation was conducted at a rotational speed of 8,000 rpm for 10 min, and a resulting polycyclooctadiene-grafted graphene nanosheet was dispersed in tetrahydrofuran. The centrifugation-dispersion process was repeated three times. A final polycyclooctadiene-grafted graphene nanosheet was dried in a vacuum oven.

It can be seen from FIG. 6 that a graphene nanosheet grafted with polycyclooctadiene on a surface is successfully prepared in this example.

### Example 6

In this example, a method for rapidly grafting polycyclooctadiene on a surface of a carbon fiber was provided. The method specifically included the following steps:

10 g of a T700 carbon fiber was placed in a Soxhlet extractor, and 300 μL of N,N-dimethylformamide was added. A resulting system was heated to 170° C. and subjected to reflux overnight, cooled to room temperature, rinsed with deionized water 3 times to 5 times, and dried in a 110° C. vacuum oven. A desized carbon fiber was added to nitric acid, subjected to a reaction for 2 h at 80° C. under stirring, then cooled to room temperature, rinsed with deionized water 3 times to 5 times, and dried in a 110° C. vacuum oven to produce a surface-hydroxylated carbon fiber. 200 μL of 3-(trimethoxysilyl) propyl acrylate was added to 20 mL of deionized water, and a pH was adjusted with hydrochloric acid to 3 to 4. The surface-hydroxylated carbon fiber was added, and stirring was conducted for 1 h at room temperature. Rinsing was conducted with deionized water 3 times to 5 times, and a resulting surface-olefin-functionalized carbon fiber was dried for later use.

20 mg of the surface-olefin-functionalized carbon fiber was added to 1,755 μL of a tetrahydrofuran solution, 245 μL of 1,5-cyclooctadiene and 4.5 mg of a Grubbs catalyst were added, and a reaction was conducted for 30 min at room temperature under stirring. 50 μL of ethyl vinyl ether was added, and stirring was conducted for 5 min. Rinsing was conducted with tetrahydrofuran 3 times to 5 times, and drying was conducted in a vacuum oven to produce a final polycyclooctadiene-grafted carbon fiber.

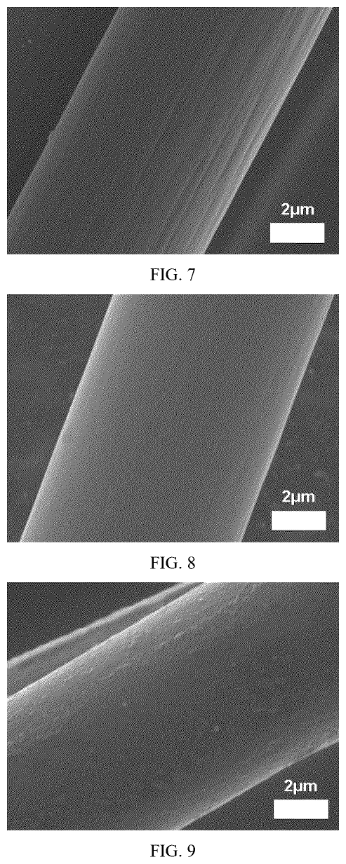

It can be seen from FIG. 7, FIG. 8, and FIG. 9 that the surface oxidation, surface olefin functionalization, and surface polycyclooctadiene grafting processes for the carbon fiber all are successfully carried out in this example.

### Example 7

In this example, a method for rapidly grafting polycyclooctadiene on a surface of a carbon fiber was provided. The method specifically included the following steps:

The surface-olefin-functionalized carbon fiber obtained in Example 6 was added to 1,950 μL of a tetrahydrofuran solution, 50 μL of 1,5-cyclooctadiene and 0.9 mg of a Grubbs catalyst were added, and a reaction was conducted for 30 min at room temperature under stirring. 10 μL of ethyl vinyl ether was added, and stirring was conducted for 5 min. Rinsing was conducted with tetrahydrofuran 3 times to 5 times, and drying was conducted in a vacuum oven to produce a final polycyclooctadiene-grafted carbon fiber.

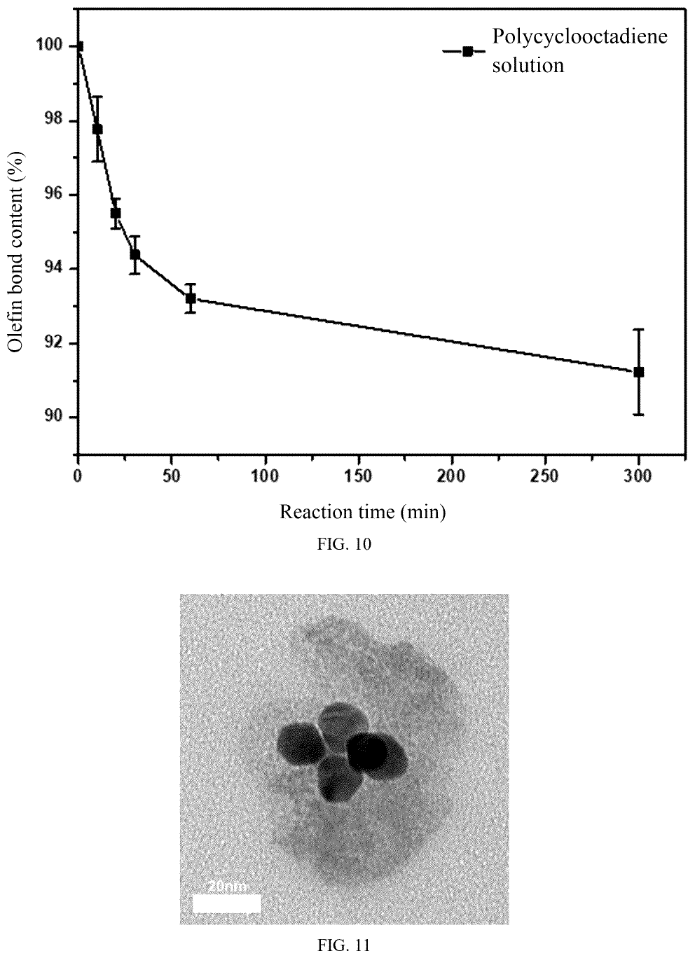

It can be seen from FIG. 10 that the reaction efficiency of grafting polycyclooctadiene on a surface of a carbon fiber based on olefin cross-metathesis is the highest within the first 30 min.

### Example 8

In this example, a method for rapidly grafting polycyclooctadiene on a surface of a gold nanoparticle was provided. The method specifically included the following steps:

100 μL of 10-undecene-1-thiol was added to 10 mL of a 0.02 M gold nanoparticle dispersion, and a reaction was conducted for 2 h at room temperature under stirring at a rate of 600 rpm. A resulting reaction solution was centrifuged for 10 min at a rotational speed of 8,000 rpm, and a resulting supernatant was discarded. A resulting surface-olefin-functionalized gold nanoparticle was dispersed in 1,755 μL of a tetrahydrofuran solution, 245 μL of 1,5-cyclooctadiene and 4.5 mg of a Grubbs catalyst were added, and a reaction was conducted for 30 min at room temperature under stirring. 50 μL of ethyl vinyl ether was added, and stirring was conducted for 5 min. Centrifugation was conducted at a rotational speed of 8,000 rpm for 10 min, and a resulting polycyclooctadiene-grafted gold nanoparticle was dispersed in tetrahydrofuran. The centrifugation-dispersion process was repeated three times to produce a final polycyclooctadiene-grafted gold nanoparticle.

It can be seen from FIG. 11 that a gold nanoparticle grafted with polycyclooctadiene on a surface is successfully prepared in this example.

### Example 9

In this example, a method for preparing a polycyclooctadiene-grafted carbon fiber-reinforced polypropylene composite specimen was provided, specifically including the following steps:

1,150 mg of a polypropylene granule and 15 mg of the polycyclooctadiene-grafted carbon fiber obtained in Example 6 were added to a 80 mm*10 mm*2 mm stainless steel mold, and the mold was placed in a platen vulcanizing machine heated to 210° C. and kept at the 210° C. for 20 min under a pressure of 7.5 MPa. The mold was then cooled at 20° C. for 0.5 h, demolding was conducted, and a product was placed for 48 h at a temperature of 25° C. and a relative humidity of 50% to produce the polycyclooctadiene-grafted carbon fiber-reinforced polypropylene composite specimen.

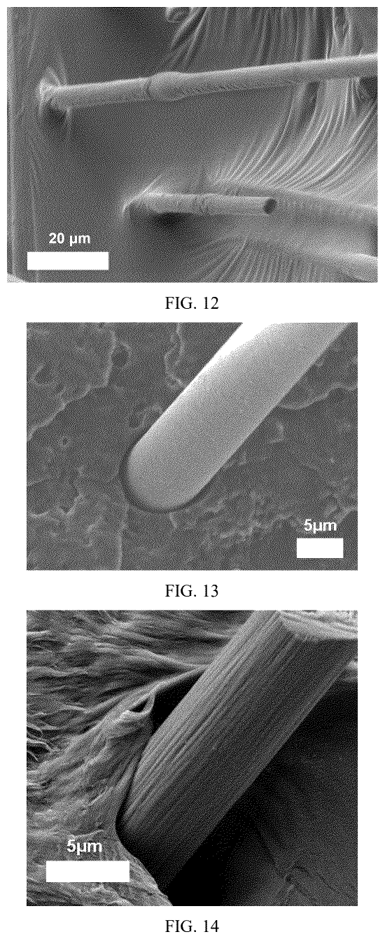

It can be seen from FIG. 12 that, after the polycyclooctadiene-grafted carbon fiber-reinforced polypropylene composite specimen is broken, there is an obvious polymer layer on an exposed carbon fiber surface.

### Example 10

In this example, a method for preparing a polycyclooctadiene-grafted carbon fiber-reinforced polypropylene composite specimen was provided, specifically including the following steps:

1,140 mg of a polypropylene granule and 25 mg of the polycyclooctadiene-grafted carbon fiber obtained in Example 6 were added to a 80 mm×10 mm×2 mm stainless steel mold, and the mold was placed in a platen vulcanizing machine heated to 210° C. and kept at the 210° C. for 20 min under a pressure of 7.5 MPa. The mold was then cooled at 20° C. for 0.5 h, demolding was conducted, and a product was placed for 48 h at a temperature of 25° C. and a relative humidity of 50% to produce the polycyclooctadiene-grafted carbon fiber-reinforced polypropylene composite specimen.

### Comparative Example 1

In this comparative example, a method for preparing a polypropylene specimen was provided, specifically including the following steps:

1,165 mg of a polypropylene granule was added to a 80 mm×10 mm×2 mm stainless steel mold, and the mold was placed in a platen vulcanizing machine heated to 210° C. and kept at the 210° C. for 20 min under a pressure of 7.5 MPa. The mold was then cooled at 20° C. for 0.5 h, demolding was conducted, and a product was placed for 48 h at a temperature of 25° C. and a relative humidity of 50% to produce the polypropylene specimen.

### Comparative Example 2

In this comparative example, a method for preparing a non-grafting-modified carbon fiber-reinforced polypropylene composite specimen was provided, specifically including the following steps:

1,150 mg of a polypropylene granule and 15 mg of a non-grafting-modified carbon fiber were added to a 80 mm×10 mm×2 mm stainless steel mold, and the mold was placed in a platen vulcanizing machine heated to 210° C. and kept at the 210° C. for 20 min under a pressure of 7.5 MPa. The mold was then cooled at 20° C. for 0.5 h, demolding was conducted, and a product was placed for 48 h at a temperature of 25° C. and a relative humidity of 50% to produce the non-grafting-modified carbon fiber-reinforced polypropylene composite specimen.

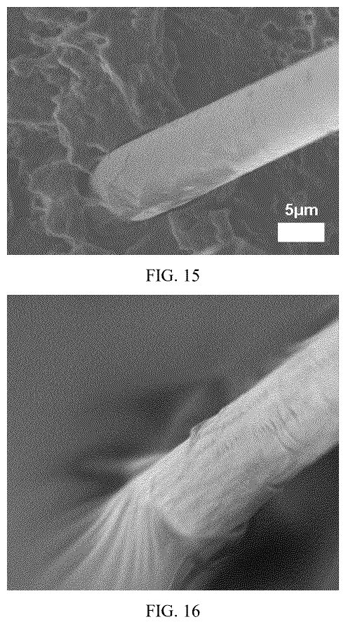

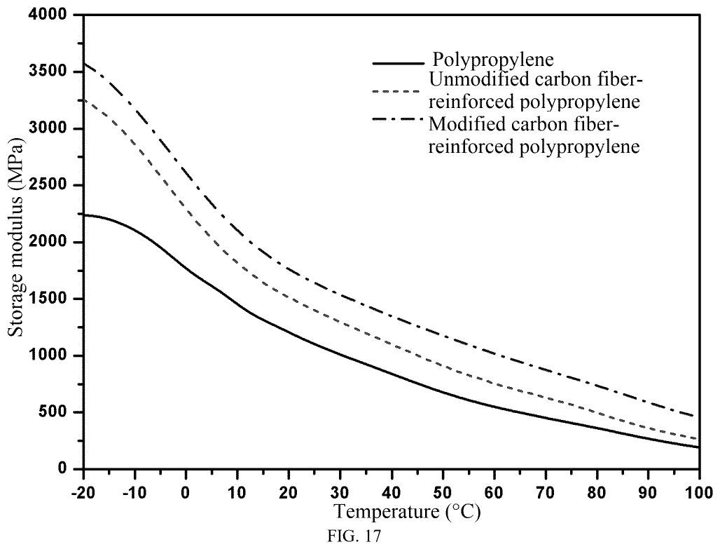

It can be seen from the comparison of FIG. 13 and FIG. 14 with FIG. 15 and FIG. 16 that, in the polycyclooctadiene-grafted carbon fiber-reinforced polypropylene composite specimen, two phases are tightly connected with excellent interfacial compatibility. It can be seen from FIG. 17 that the polycyclooctadiene-grafted carbon fiber-reinforced polypropylene composite specimen exhibits significantly-improved thermomechanical performance compared with the unmodified carbon fiber-reinforced polypropylene composite specimen.

In summary, in Examples 1 to 3, with an olefin-functionalized carbon nanotube as a model matrix, 1,5-cyclooctadiene as a polymerization monomer, a Grubbs catalyst as an initiator, and ethyl vinyl ether as a terminator, surface olefin cross-metathesis is conducted to prepare a polycyclooctadiene-grafted carbon nanotube. Basic steps are as follows: With nitric acid as an oxidant and 3-(trimethoxysilyl) propyl acrylate as an olefin functionalizing reagent, a surface of a carbon nanotube is subjected to hydroxylation and olefin functionalization modification. A modified carbon nanotube is dispersed in a solution of 1,5-cyclooctadiene in tetrahydrofuran, and a Grubbs catalyst is added. A polymerization time is controlled by controlling a time point at which ethyl vinyl ether is added to a system. After a reaction is completed, centrifugation is conducted to produce a carbon nanotube grafted with polycyclooctadiene on a surface. Compared with the surface-initiated ring-opening metathesis polymerization technology, the present disclosure adopts a chain-transfer reaction as an alternative method, which avoids the growth of polymer chains from the surface and improves the reaction rate. The present disclosure develops a method of modifying a material through rapid surface grafting. The process is simple and reliable, and has a promising application prospect.

Further, in Examples 9 and 10, with polypropylene as a model thermoplastic resin matrix and a surface-polyolefin-grafted carbon fiber as a reinforcing material, a carbon fiber-reinforced polypropylene composite is prepared through compression molding. The compatibility between a reinforcing material and a thermoplastic resin matrix is evaluated through cross-sectional morphology and mechanical performance characterization. Basic steps are as follows: A polycyclooctadiene-grafted carbon fiber is produced through surface chain-transfer cross-metathesis, and a composite is prepared through compression molding from the modified carbon fiber and a polypropylene resin. The compatibility of a carbon fiber before and after modification with a polypropylene resin is evaluated through scanning electron microscopy and dynamic thermomechanical analysis. Although the present disclosure only provides a use of compounding the polycyclooctadiene-grafted carbon fiber obtained in Example 6 with the polypropylene resin, it can be seen based on a same composite reinforcement mechanism that the materials of Examples 1 to 5, 7, and 8 are also applicable. Compared with the prior art, the present disclosure develops a method for improving the compatibility of a reinforcing material with a thermoplastic resin matrix by compounding a surface-polyolefin-grafted reinforcement with a thermoplastic resin.

Compared with the prior art, the present disclosure has the following beneficial effects:
1. The present disclosure has developed a new process for preparing a polyolefin-grafted nanomaterial through surface olefin cross-metathesis instead of ring-opening metathesis polymerization, which avoids the growth of polymer chains from a surface of a material, increases the reaction rate, and demonstrates a promising prospect for industrialization.
2. The mechanism of preparing a polycyclooctadiene-grafted carbon nanotube in the present disclosure is as follows: under the action of the Grubbs catalyst, an olefin bond on a surface of an olefin-functionalized carbon nanotube undergoes chain-transfer cross-metathesis with a 1,5-cyclooctadiene polymerization product.
3. The polycyclooctadiene-grafted carbon nanotubes with different molecular weights prepared with a carbon nanotube as a model monomer in the present disclosure have a grafted polymer layer with a controllable thickness, and can meet the requirements of different application scenarios.
4. The present disclosure develops a method for improving the compatibility of a reinforcing material with a thermoplastic resin matrix. This method adopts polypropylene as a model thermoplastic resin matrix and a modified carbon fiber as a reinforcing material, and has a wide market application range.
5. In the present disclosure, a material is characterized with the combination of scanning electron microscopy and dynamic thermomechanical analysis, which avoids the reliance on a single characterization technique.

The specific implementations of the present disclosure are described above. It should be noted that the present disclosure is not limited to the above specific implementations, and those skilled in the art can make various variations or modifications within the scope of the claims without affecting the essence of the present disclosure.

What is claimed is:

1. A method for modifying a material through rapid surface grafting, comprising: with an olefin-functionalized nanomaterial as a model matrix, a cycloolefin as a polymerization monomer, and a Grubbs catalyst as an initiator, conducting surface olefin cross-metathesis to prepare a polyolefin-grafted nanomaterial.

2. The method for modifying the material through rapid surface grafting according to claim 1, wherein a nanomaterial comprises at least one of a carbon nanotube, a graphene nanosheet, a carbon fiber, a silica microsphere, a gold nanoparticle, a glass fiber, an aramid fiber, and an ultra-high-molecular-weight polyethylene fiber; and the cycloolefin comprises at least one of cyclohexene, cycloheptene, cyclooctene, norbornene, norbornadiene, cyclododecene, and 1,5-cyclooctadiene.

3. The method for modifying the material through rapid surface grafting according to claim 1, wherein the polymerization is terminated by adding ethyl vinyl ether to a system.

4. The method for modifying the material through rapid surface grafting according to claim 1, wherein the olefin-functionalized nanomaterial is produced by grafting a long-chain alkyl molecule with an α-olefin bond on a surface of a nanomaterial.

5. The method for modifying the material through rapid surface grafting according to claim 1, wherein when a nanomaterial is a carbon nanotube, a graphene nanosheet, or a carbon fiber, the olefin-functionalized nanomaterial is prepared through a process comprising the following steps:
A1, nitric acid oxidation: adding the nanomaterial to nitric acid, heating to a temperature of 80° C. to 90° C., holding the temperature of 80° C. to 90° C. for 2 h to 12 h, cooling, and centrifuging; and
A2, under an acidity and in the presence of water, subjecting an oxidized nanomaterial and 3-(trimethoxysilyl) propyl acrylate to a reaction for 1 h to 8 h at 20° C. to 30° C. under stirring, washing, and drying to produce the olefin-functionalized nanomaterial, wherein the acidity refers to a pH of 3 to 4.

6. The method for modifying the material through rapid surface grafting according to claim 5, wherein the nanomaterial, the nitric acid, and the 3-(trimethoxysilyl) propyl acrylate are in a mass ratio of 1:100:10 to 1:20,000:25; and a mass ratio of the 3-(trimethoxysilyl) propyl acrylate to the water is 1:25 to 1:200.

7. The method for modifying the material through rapid surface grafting according to claim 1, wherein when a nanomaterial is a silica microsphere, the olefin-functionalized nanomaterial is prepared as follows: under an acidity and in the presence of water, subjecting the nanomaterial and 3-(trimethoxysilyl) propyl acrylate to a reaction for 1 h to 8 h at 20° C. to 30° C. under stirring, washing, and drying, wherein the acidity refers to a pH of 3 to 4; and when the nanomaterial is a gold nanoparticle, the olefin-functionalized nanomaterial is prepared as follows: in the presence of water, subjecting the nanomaterial and 10-undecene-1-thiol to a reaction for 1 h to 8 h at 20° C. to 30° C. under stirring, washing, and drying.

8. The method for modifying the material through rapid surface grafting according to claim 1, wherein the surface olefin cross-metathesis comprises the following steps:
B1, in the presence of a tetrahydrofuran solvent and the Grubbs catalyst, subjecting the olefin-functionalized nanomaterial and the cycloolefin to a reaction for 30 min to 4 h at 20° C. to 30° C. under stirring; and
B2, adding ethyl vinyl ether for termination, centrifuging, washing, and drying to produce the polyolefin-grafted nanomaterial.

9. The method for modifying the material through rapid surface grafting according to claim 8, wherein a mass ratio of the olefin-functionalized nanomaterial to the cycloolefin is 1:1 to 1:100; a molar ratio of the cycloolefin to the tetrahydrofuran solvent is 1:4 to 1:400; and a molar ratio of the Grubbs catalyst to the cycloolefin is 1:20 to 1:400.

10. A use of a polyolefin-grafted nanomaterial prepared by the method according to claim 1, comprising: with a thermoplastic resin as a matrix and the polyolefin-grafted nanomaterial as a reinforcing material, preparing a nanomaterial-reinforced resin material, wherein the thermoplastic resin comprises at least one of polyethylene, polyvinyl chloride, polystyrene, polyformaldehyde, polycarbonate, polyamide, and polypropylene.

11. The use according to claim 10, wherein in the method, a nanomaterial comprises at least one of a carbon nanotube, a graphene nanosheet, a carbon fiber, a silica microsphere, a gold nanoparticle, a glass fiber, an aramid fiber, and an ultra-high-molecular-weight polyethylene fiber; and the cycloolefin comprises at least one of cyclohexene, cycloheptene, cyclooctene, norbornene, norbornadiene, cyclododecene, and 1,5-cyclooctadiene.

12. The use according to claim 10, wherein in the method, the polymerization is terminated by adding ethyl vinyl ether to a system.

13. The use according to claim 10, wherein in the method, the olefin-functionalized nanomaterial is produced by grafting a long-chain alkyl molecule with an α-olefin bond on a surface of a nanomaterial.

14. The use according to claim 10, wherein in the method, when a nanomaterial is a carbon nanotube, a graphene nanosheet, or a carbon fiber, the olefin-functionalized nanomaterial is prepared through a process comprising the following steps:
A1, nitric acid oxidation: adding the nanomaterial to nitric acid, heating to a temperature of 80° C. to 90° C., holding the temperature of 80° C. to 90° C. for 2 h to 12 h, cooling, and centrifuging; and
A2, under an acidity and in the presence of water, subjecting an oxidized nanomaterial and 3-(trimethoxysilyl) propyl acrylate to a reaction for 1 h to 8 h at 20° C. to 30° C. under stirring, washing, and drying to produce the olefin-functionalized nanomaterial, wherein the acidity refers to a pH of 3 to 4.

15. The use according to claim 14, wherein in the method, the nanomaterial, the nitric acid, and the 3-(trimethoxysilyl) propyl acrylate are in a mass ratio of 1:100:10 to 1:20,000:25; and a mass ratio of the 3-(trimethoxysilyl) propyl acrylate to the water is 1:25 to 1:200.

16. The use according to claim 10, wherein in the method, when a nanomaterial is a silica microsphere, the olefin-functionalized nanomaterial is prepared as follows: under an acidity and in the presence of water, subjecting the nanomaterial and 3-(trimethoxysilyl) propyl acrylate to a reaction for 1 h to 8 h at 20° C. to 30° C. under stirring, washing, and drying, wherein the acidity refers to a pH of 3 to 4; and when the nanomaterial is a gold nanoparticle, the olefin-functionalized nanomaterial is prepared as follows: in the presence of water, subjecting the nanomaterial and 10-undecene-1-thiol to a reaction for 1 h to 8 h at 20° C. to 30° C. under stirring, washing, and drying.

17. The use according to claim 10, wherein in the method, the surface olefin cross-metathesis comprises the following steps:
B1, in the presence of a tetrahydrofuran solvent and the Grubbs catalyst, subjecting the olefin-functionalized nanomaterial and the cycloolefin to a reaction for 30 min to 4 h at 20° C. to 30° C. under stirring; and
B2, adding ethyl vinyl ether for termination, centrifuging, washing, and drying to produce the polyolefin-grafted nanomaterial.

18. The use according to claim 17, wherein in the method, a mass ratio of the olefin-functionalized nanomaterial to the cycloolefin is 1:1 to 1:100; a molar ratio of the cycloolefin to the tetrahydrofuran solvent is 1:4 to 1:400; and a molar ratio of the Grubbs catalyst to the cycloolefin is 1:20 to 1:400.
